(19) United States
(12) Patent Application Publication
(10) Pub. No.: US 2019/0035273 A1
(43) Pub. Date: Jan. 31, 2019

(54) P.U.M.A. - Parking Unlimited Mobile App

(71) Applicant: Steven A. Garrick, Columbia, SC (US)

(72) Inventor: Steven A. Garrick, Columbia, SC (US)

(21) Appl. No.: 15/660,724

(22) Filed: Jul. 26, 2017

(51) Int. Cl. G08G 1/14; G01C 21/36

(52) U.S. Cl. CPC G08G 1/144; G06Q 2240/00; G01C 21/3667

(57) ABSTRACT

The present invention discloses P.U.M.A.—Parking Unlimited Mobile App. This is a real time app running on a user's device that enable the user to input a location and see all parking spots available (whether public parking, or any privately owned spots including those of small entities) within a certain distance from that location and direct the driver turn-by-turn to the parking spot of their choosing, using already existing Internet mapping and other software.

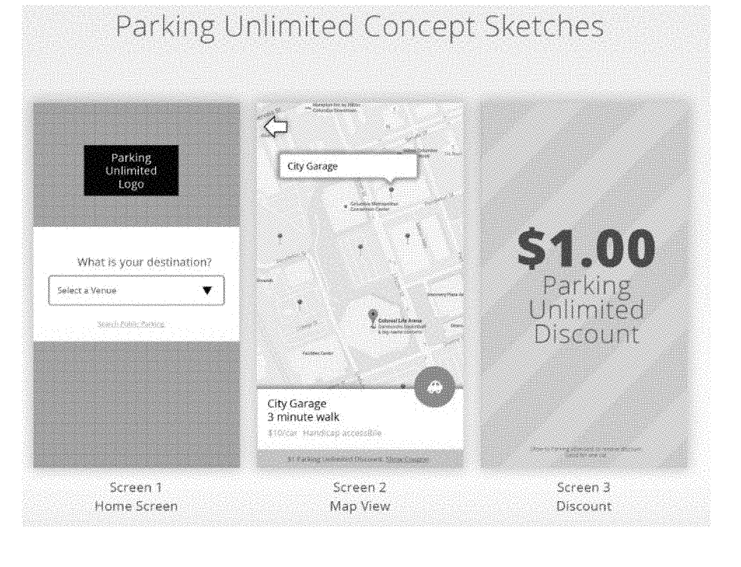

### CROSS REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

Parking in any large population center has always been problematic for many reasons. It has up to now been hard to know what parking is available near one's destination. Also, many small lot owners and those owning residential property with space to spare have traditionally had much difficulty publicizing the availability of their parking spots to the general public, The inability to bring together the driver in need of a parking spot and any small entity owning one or more parking spots that may be available can cause much inconvenience to the driver and a lack of income to the owner of the parking spots.

### 1. Field of the Invention

G08G1/14, G08G1/141, G08G1/143, G008G1/144, G008G1/145, G08G1/146, G08G1/147, G08G1/148

### 2. Description of Related Art Including Information Disclosed Under 37 CFR 1.97 and 1.98

Canadian Published Patent Application CA2725691A1 discloses -a navigation device that receives information about free parking spaces and guides the user turn by turn to the space, This device is a specialized hardware device that uses its own proprietary GPS and location information whereas this invention is distinguished by using already existing mapping software such as Google Maps or Apple Maps or whatever such software is available to the device. This invention further distinguishes from the prior art disclosed herein as being a downloadable app as opposed to a self contained hardware device.

U.S. Pat. No. 7,893,847 B2 discloses a parking availability determiner that uses sensors. This invention does not need sensors or any sort of hardware monitoring.

U.S. Pat. No. 8,432,297 B2 discloses an integrated parking information system but it is for municipal street parking spaces, probably metered. This invention is distinguished by being much more general in directing customers to a municipal parking lot, privately owned lot, privately owned yard, a local business lot or any other location where parking may be available based on spot owner input.

U.S. Pat. No. 9,076,336 B2 discloses a method of recommending a parking space comprises obtaining a driver identity, detecting parking events, locations, and characteristics of the parking locations, and storing the characteristics in a parking information database. Parking preferences of the driver may then be determined based at least in part on the characteristics, and used to make parking recommendations for that driver. This invention is distinguished by showing private residential space as part of it's collection of parking spaces.

U.S. Pat. No. 9,177,475 B2 discloses a driver behavior system which aims to predict which parking spaces may be open at the particular time the driver wishes to park. The system relies on data that may or may not be real time or accurate. It also does not allow payment through the app for parking and thus reservation of a spot. It predicts where the next open parking spot will be. It also presents a route to the driver but does not direct turn-by-turn as this invention does. This invention accesses real-time data presented by the owners of the parking spaces and thus no prediction is necessary.

US Published Patent Applicatio 2016/0180712 A1 discloses a database of off-street parking spaces and a management module, each parking spot identified by a UUID. It does not disclose private residence parking spot management. This invention does not need UID or other unique identifiers to operate.

Non-Patent Literature reference titled “White Plains Launches ParkWhitePlains, Mobile Parking App 1st Municipal Mobile Parking App in Westchester” discloses a parking mobile app which allows the user to book remotely and also the app will display the available public parking location in a map. The app is specific for municipal parking only and does not generalize to any other source of parking spots as this invention does. The app also does not direct the customer turn by turn to the parking spot as this invention does.

Non-Patent Literature reference titled “Parking Facilities in New York City” discloses a website where the location of available parking space related to user destination is displayed on the map. The map will also display additional information such as whether the parking lot is municipal garage off-street parking to the user. The disclosure is not a downloadable app as is this invention.

### BRIEF SUMMARY OF THE INVENTION

The preferred embodiment of the invention is a real time parking app comprising the following features:
1. A user can download the app to any network capable personal device.
2. The user can select the location of an event (such as a concert, a park, basketball game), the app will show where they can park using google/apple maps and whether it is municipal parking lot, privately owned lot, someone's yard or local business lots.
3. The app will provide information such as whether the lot is full or not, and be able to reserve VIP spots and/or arrange for valet service if desired.
4. It will direct the user turn by turn to the lot and give them the cost including any discounts.
5. A possible means to allow the user to pay for parking through the app can also be provided.

### Advantages

1. Flexible parking app to track parking lot capacity.
2. This app enables automakers to include it in on-board navigation systems on vehicles.

### BRIEF DESCRIPTION OF THE SEVERAL VIEWS OF THE DRAWING

The first image (screen 1) shows the app's screen requesting the user's location input.
The second image (screen 2) shows the system's response detailing the available parking spots using Google or Apple maps.

The third image (screen 3) shows a particular discount on the price of parking available to this user.

### DETAILED DESCRIPTION OF THE INVENTION

Embodiments of the invention are discussed below with reference to the images. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents, of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “an example embodiment,” “various embodiments,” etc., may indicate that the embodiments) of the invention so described may include a particular feature, structure, or characteristic, but not every embodiment necessarily includes the particular feature, structure, or characteristic. Further, repeated use of the phrase “in one embodiment” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The PUMA app itself is a simple concept; anyone will be able to download the app to their device. If there is a family event in a park, a concert, baseball game or anything along those lines, the PUMA app will show them where they can park, and at what cost and any discounts, whether it be a municipal parking lot, privately owned lot, privately owned yard or a local business lot.

The PUMA app will show the viewer where parking is available by utilizing existing internet based mapping software such as Google Maps, Apple Maps, Yahoo Maps and MapQuest. It will direct the customer turn by turn to the lot and also give them the cost to park at that location and perhaps any discounts available to that customer, either for the particular parking location or for the customer in general.

As the app grows and features are added it will be able to accept and process real time information from the lot owners such as whether the lot is full or not, also enabling the client to reserve (VIP) spots and/or arrange for valet service if desired.

It can also be available to automakers for inclusion into their onboard navigation systems.

The PUMA app will be customize-able for different software systems operating in municipal garages and or city county parking lots, etc.

The PUMA app will have the flexibility to grow to track parking lot capacity when given access to parking lot open source operating systems.

The PUMA app is unique in its design and function because it does not need UID's unique identifiers, sensors, magnetic strips or anything externally placed or mounted.

The PUMA app is specifically developed to provide drivers going to special events, concerts, sporting events, community events, even national events with information and directions on where they can park, whether it be a garage, open air parking lot, privately owned residential or commercial space, or municipal lot.

The PUMA app is not a system that tells or directs drivers to metered parking spaces. The PUMA apps simplicity is that it functions to direct drivers to parking lots, garages or any open space that is available for parking to the public or private sector.

The PUMA APP is not based on driver monitoring in collection or input so no sensors are required or needed.

The PUMA app will be available for download from Google Play and/or any other major device app downloading destination.

The PUMA app will continually connect with private, public, and municipal parking lot owners to keep its database updated for patrons.

The PUMA app does not need electronic sensors or surveillance device to function/operate as it is software that connects to and takes advantage of already existing technologies.

No other product on the market today gives private owners of parking spots or small lot owners the ability to advertise the availability of their parking spots as this invention does. Many property owners may want to rent out a part of their property as parking space but have no efficient way to publicize this. This invention allows these small entity owners to contribute to the parking space collection in any location and addresses a long felt but unsolved need for such ability. Also, the likelihood of large profits for these small entities may be an unexpected result due to this invention's implementation.

I claim:

1. A system comprising an app that is downloadable to any device with means to show a driver where to park, and at what cost, whether it be a municipal parking lot, privately owned lot, privately owned yard or a local business lot.

2. The app according to claim 1 comprising means to show the viewer where parking is available by utilizing existing internet based mapping software such as Google Maps, Apple Maps, Yahoo Maps and MapQuest.

3. The app according to claim 2 comprising means to direct the customer turn by turn to the lot and also give them the cost to park at that location and perhaps any discounts available to that customer, either for the particular parking location or for the customer in general.

4. The app according to claim 3 with means to give real time information from the lot owners such as whether the lot is full or not, also enabling the client to reserve (VIP) spots and/or arrange for valet service if desired.

5. The app according to claim 4 with means to be customizable for different software systems operating in municipal garages and or city parking lots, etc.

6. The app according to claim 5 with means to track parking lot capacity when given access to parking lot open source operating systems.
